(19) United States
(12) Patent Application Publication
(10) Pub. No.: US 2012/0297567 A1
(43) Pub. Date: Nov. 29, 2012

(54) WINDSCREEN WIPER HAVING A HOLLOW WIPING HEAD

(76) Inventor: Michael L. Hyer, Benbrook, TX (US)

(21) Appl. No.: 13/359,337

(22) Filed: Jan. 26, 2012

Related U.S. Application Data
(60) Provisional application No. 61/436,551, filed on Jan. 26, 2011.

(51) Int. Cl. B60S 1/34; B60S 1/38

(52) U.S. Cl. 15/250.32; 15/250.38

(57) ABSTRACT

A windscreen wiper includes a wiping element having a head portion and a wiping portion. The wiping portion of the wiping element includes a wiping head and a wiping tip extending from the wiping head. The wiping head has in cross-section a pair of upper legs and a pair of lower legs, the upper legs and the lower legs sized and arranged such that the upper legs and the lower legs form a deltoid shape. The upper legs and the lower legs further define a deltoid-shaped channel disposed within the wiping head.

### CROSS-REFERENCE TO RELATED APPLICATIONS

This application claims the benefit of U.S. Provisional Application No. 61/436,551, filed Jan. 26, 2011, which is hereby incorporated by reference.

### BACKGROUND

1. Field of the Invention

The invention relates generally to wipers for removing water, snow, dirt, or other debris from a windscreen or other surface, more specifically to an improved wiping element that improves pressure distribution across the length of the wiper.

2. Description of Related Art

Automobile windscreens, also referred to as windshields, are often in need of cleaning or wiping during use of the automobile. Water, dirt, snow, or other debris may be deposited on the windscreen, and automobiles are typically provided with windscreen wipers to remove these substances. Like the varied design of automobiles, automobile windscreens vary widely in shape, size, rake, and curvature. Because of these variations, it is difficult to design a particular windscreen wiper that will perform well on many different windscreens. The design is further complicated by the varying paths that windscreen wipers may be required to travel on different automobiles. As the windscreen wipers are reciprocally moved across a windscreen, the contour of the windscreen encountered by the wiper may change.

One characteristic of a well-designed windscreen wiper is to closely follow the contour of the windscreen throughout the travel path of the windscreen wiper. To obtain good wipe performance and minimal noise, the pressure exerted along a length of the windscreen wiper should be relatively uniform. To achieve this, conventional “articulated frame” wipers have included multiple frame arms attached to a main frame or secondary frames at articulation joints. The articulation joints allow the windscreen wiper to take on varying angles during the wiping process and provide a more uniform distribution of pressure across the length of the windscreen wiper. This allows the windscreen wiper to have notable wiping performance that is not necessarily present in other windscreen wiper designs.

### SUMMARY

The problems presented by existing windscreen wipers are solved by the systems and methods described herein. In one illustrative embodiment, a windscreen wiper includes a wiping element having a head portion and a wiping portion. The head portion includes a pair of channels, and each channel is disposed along a lateral side of the head portion. A spring-like support element includes a pair of elongated splines and each elongated spline is received by one of the channels of the head portion. The wiping portion of the wiping element includes a wiping head and a wiping tip extending from the wiping head. The wiping head has in cross-section a pair of upper legs and a pair of lower legs, the upper legs and the lower legs sized and arranged such that the upper legs and the lower legs form a deltoid shape. The upper legs and the lower legs further define a deltoid-shaped channel disposed within the wiping head.

In another illustrative embodiment, a windscreen wiper includes a wiping element having a head portion and a wiping portion. The head portion is adapted to be coupled to a wiper frame, and the wiping portion includes in cross-section a pair of upper legs and a pair of lower legs. The upper legs and the lower legs are sized and arranged such that the upper legs and the lower legs form a deltoid shape. The upper legs and the lower legs further define a channel disposed within the wiping head.

In yet another illustrative embodiment, a windscreen wiper includes a wiping element having a head portion and a wiping portion. The head portion includes a pair of channels, each channel disposed along a lateral side of the head portion. A spring-like support element includes a pair of elongated splines, and each elongated spline is received by one of the channels of the head portion. The wiping portion of the wiping element includes a wiping head and a wiping tip extending from the wiping head. The wiping head has in cross-section upper and lower legs, the upper legs and the lower legs defining and surrounding a channel disposed within the wiping head. The upper and lower legs each have a substantially uniform thickness.

Other objects, features, and advantages of the illustrative embodiments will become apparent with reference to the drawings, detailed description, and claims that follow.

### BRIEF DESCRIPTION OF THE DRAWINGS

FIG. 1 illustrates an exploded, isometric view of a windscreen wiper having a spring-like support element and wiping element according to an illustrative embodiment;

FIG. 2 illustrates a partial isometric view of the windscreen wiper of FIG. 1;

FIG. 3 illustrates a cross-sectional side view of the wiping element of FIG. 1 taken at 3-3;

FIG. 4 illustrates a cross-sectional side view of the support element of FIG. 1 and a wiping element having a cross-section similar to that illustrated in FIG. 3, the support element and wiping element being illustrated in an un-loaded state;

FIG. 5 illustrates a cross-sectional side view of the support element of FIG. 1 and a wiping element having a cross-section similar to that illustrated in FIG. 3, the support element and wiping element being illustrated in a loaded state;

FIG. 6 illustrates a cross-sectional side view of a wiping element according to an illustrative embodiment;

FIG. 7 illustrates a cross-sectional side view of a wiping element according to an illustrative embodiment;

FIG. 8 illustrates a cross-sectional side view of a wiping element according to an illustrative embodiment;

FIG. 9 illustrates a cross-sectional side view of a wiping element according to an illustrative embodiment;

FIG. 10 illustrates a graphical depiction of forces measured along a length of a beam-style windscreen wiper;

FIG. 11 illustrates a graphical depiction of forces measured along a length of a beam-style windscreen wiper that includes a wiping element similar to that illustrated in FIG. 3;

FIG. 12 illustrates a front view of a windscreen wiper having a wiping element according to an illustrative embodiment;

FIG. 13 illustrates a cross-sectional side view of the windscreen wiper and the wiping element of FIG. 12 taken at 13-13;

FIG. 14 illustrates a front view of a windscreen wiper having a wiping element according to an illustrative embodiment; and

FIG. 15 illustrates a cross-sectional side view of the windscreen wiper and the wiping element of FIG. 14 taken at 15-15.

### DETAILED DESCRIPTION OF THE ILLUSTRATIVE EMBODIMENTS

In the following detailed description of several illustrative embodiments, reference is made to the accompanying drawings that form a part hereof, and in which is shown by way of illustration specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

“Beam-style” windscreen wipers are those that typically include a spring-like support element that is curved to give the windscreen wiper, including the wiping element, a predisposed arc. In most instances, the arc of the wiping element will include a greater curvature than the curvature of the windscreen on which the windscreen wiper is being used. A force applied to the windscreen wiper by a wiper arm tends to flatten the wiping element to the contour of the windscreen. The wiper arm may be driven by a motor to reciprocally move the windscreen wiper across the windscreen.

The predisposed arc of the beam-style windscreen is necessary for the wiping element to fully conform at a proper angle to the varying angles and radii of the windscreen at all positions during operational motion. The proper arc may be theoretically and clinically predicted during initial design stages, and followed up by testing the interaction between the windscreen and the wiper. More specifically, the testing determines the ability of the support element and wiping element to bend or conform to the changes of the windscreen, especially during water removal operations as the wiper is reciprocated at approximately 45 cycles per minute across approximately four to five feet of travel in each cycle. While design prediction and subsequent testing may result in identifying an acceptable wiper design for one particular vehicle, the same wiper may not perform properly on other vehicle platforms requiring the same wiper length. This is due in part to differences in the force applied by the wiper arm on different vehicles, as well as the differences in windscreen shape and contour.

With higher wiper arm forces, the support elements and wiping element will more closely conform to the contour of a given windscreen. However, since the wiper arm typically is attached approximately midway along the length of the wiper, higher wiper arm forces may result in more compression of the wiping element near the location at which the wiper arm is attached. The compression of the wiping element in this location may change the angle that the wiping element contacts the windscreen (i.e. “angle of attack”) in this location relative to other locations along the wiping element, thereby affecting wipe quality. Additionally, the concentration of higher wiper arm forces in this location increases friction between the wiping element and the windscreen, which results in chatter and noise.

With lower arm forces and related pressure distribution variables, the wiping element may not make contact with the windscreen at all locations along the length of the wiping element as the wiping element is moved across the windscreen. This lack of contact results in missed wipe areas.

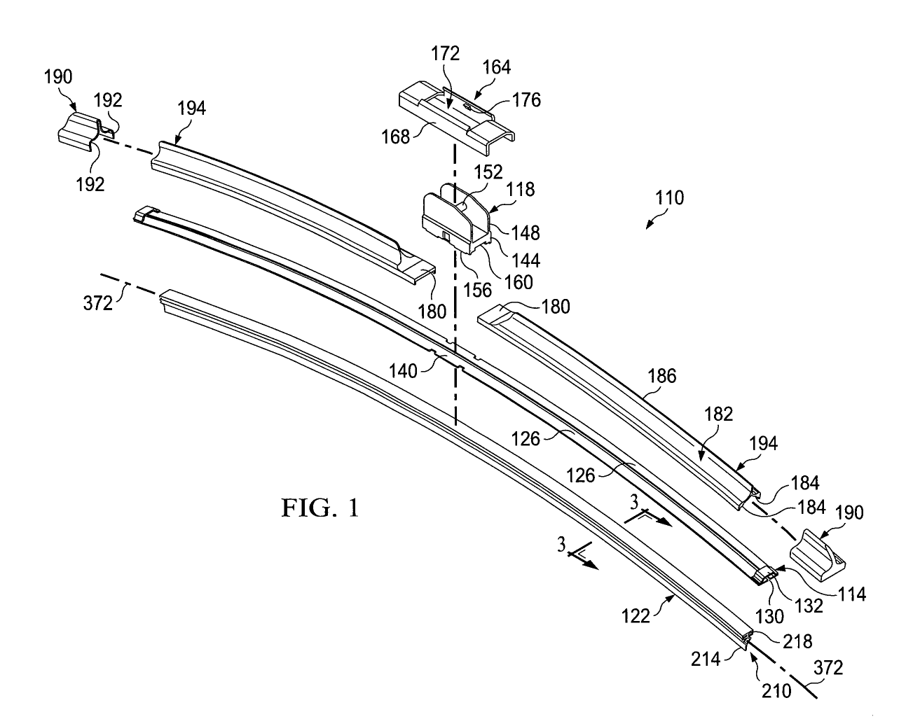

Referring to FIG. 1, a windscreen wiper 110 according to an illustrative embodiment includes a spring-like support element 114, a connection bracket 118 straddled on an upper surface of the support element 114, and a wiping element, or squeegee 122 engaged by the support element 114. The support element 114 may include two elongated splines 126 oriented substantially parallel to each other with a support channel 130 formed between the two elongated splines 126. A bridge 132 may be disposed at each end of the support element 114 to connect the two elongated splines 126. The bridge 126 may be welded or otherwise attached to each of the elongated splines 126.

The elongated splines 126 may be made from a material such as spring steel or any other suitably resilient material. The elongated splines 126 are formed in a curved, generally arcuate shape such that the elongated splines retain this predisposed arcuate shape when no force is applied to the splines 126. The predisposed, curved shape of the splines 126 allows the wiping element 122 to more closely match the contour of a windscreen, even though articulating wiper joints and other force application mechanisms associated with traditional wipers and wiper frames are not used.

The support element 114 may include a connection pad 140 on which the connection bracket 118 is configured to rest. A lower surface of the support element 114 rests against the wiping element 122 when the windscreen wiper 110 is assembled. The connection bracket 118 may include a base 144, two parallel plates 148 extending upwardly from two lateral sides of the base 144 respectively, a bar 152 connected between the two parallel plates 148, and a clip member 156 extending inwardly from each lateral side of a bottom of the base 144 in order to secure the connection bracket 118 to the support element 114. The base 144 of the connection bracket 118 may include an indentation 160 formed on a bottom surface of the base 144 for mating with an upper portion of the wiping element 122.

A bracket cover 164 may be provided and includes a generally u-shaped frame 168 having an aperture 172 which is configured to receive the connection bracket 118 when the windscreen wiper 110 is assembled. On an inner surface of the frame 168, a detent 176 or other locking member may be provide to engage a complementary recess or member on the connection bracket 118. When secured to either the connection bracket 118 or another portion of the windscreen wiper 110, the bracket cover 164 provides protection for the connection bracket 118 from snow, ice, dirt, and other debris. The connection bracket 118 also may cover inside ends 180 of a pair of wiper covers 182. In the embodiment illustrated in FIG. 1, each wiper cover 182 includes a pair of side walls 184 diverging to an apex 186. Each side wall 184 may be relatively planar, concave, or convex. The wiper covers 182 are configured to be placed over the support element 114 and wiping element 122 when the windscreen wiper 110 is assembled. The wiper covers 182 may be made from a synthetic material such as a plastic, or may be made from a silicone based compound or a natural rubber compound. When covering the support element 114 and wiping element 122, the wiper covers 182 provide protection from snow, ice, dirt, and other debris. The wiper covers 182 may also serve as a wind spoiler that uses air flow around the automobile to assist in holding the windscreen wiper 110 against the windscreen.

End caps 190 having side walls 192 of similar shape to side walls 184 are provided to cover outside ends 194 of wiper covers 182. The dimensions between side walls 192 is preferably slightly greater than the outer dimensions associated with side walls 184. This allows the end caps 190 to be placed over the outside ends 194 when the windscreen wiper is assembled.

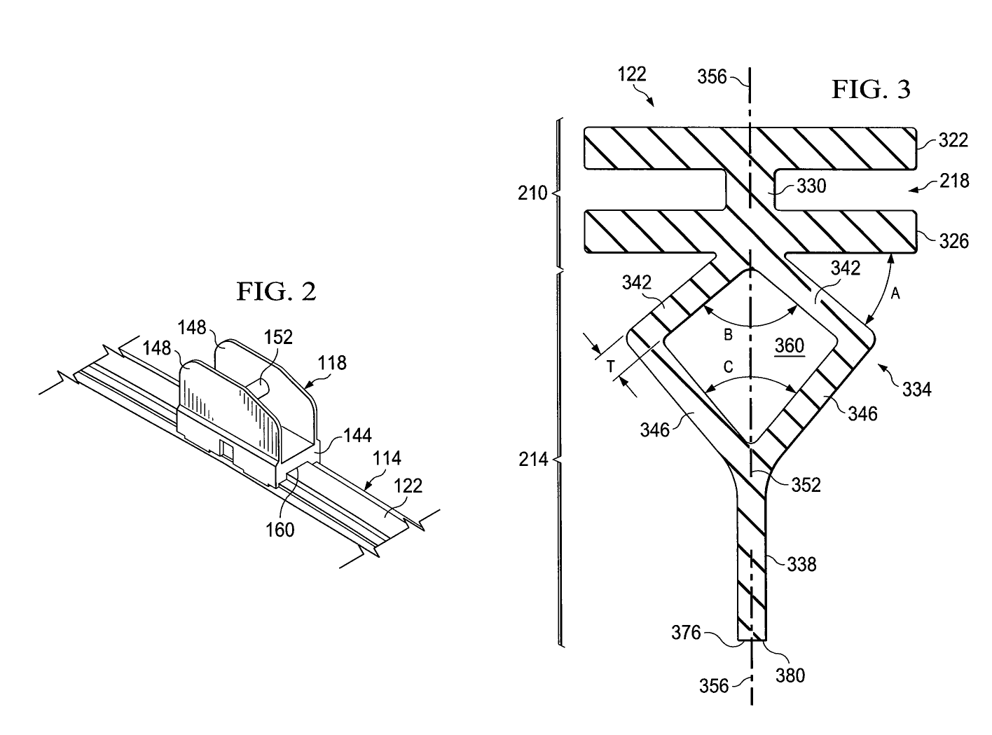

Referring still to FIGS. 1 and 2, but also to FIG. 3, the wiping element 122 may include a head portion 210 and a wiping portion 214 connected to the head portion 210. The head portion 210 includes a channel 218 formed along each lateral side of the head portion 210, and each channel 218 is configured to receive one of the elongated splines 126 of the support element 114.

Referring more specifically to FIG. 3, the head portion 210 includes an upper flange 322 and a lower flange 326 connected by an upper web 330. Together, the upper flange 322, lower flange 326, and upper web 330 define the channels 218 positioned on each side of the web 330. The upper flange 322, the lower flange 326, the upper web 330, and the channels 218 may run an entire length of the wiping element 122.

The wiping portion 214 may be connected to the head portion 210 by a lower web similar to upper web 330, or alternatively the walls of the wiping portion may be more directly connected to the head portion 214 as illustrated in FIG. 3. The wiping portion 214 includes a wiping head 334 and a wiping tip 338. In the embodiment illustrated in FIG. 3, the wiping head 334 includes upper legs 342 and lower legs 346 arranged in a quadrilateral shape. More specifically, in the embodiment illustrated in FIG. 3, the cross-sectional shape of the wiping head 334 is a kite or deltoid shape, which includes two pairs of congruent adjacent sides. In other words, a length of each upper leg 342 is the same as a length of the other upper leg 342. Similarly, a length of each lower leg 346 is equal to a length of the other lower leg 346. Additionally, the kite or deltoid shape of the wiping head 334 is one in which an axis of symmetry 352 exists along a diagonal of the shape. With respect to the wiping element 122, the axis of symmetry 352 is coaxial with an axis of symmetry 356 of the wiping element 122.

The arrangement of the upper legs 342 and lower legs 346 defines a channel 360 within the wiping head 334. In one embodiment, the channel 360 runs an entire length of the wiping element 122. In another embodiment, the channel 360 may be included within the wiping element 122 along the entire length except at each end of the wiping element 122. Such an arrangement may assist in preventing snow, ice, dirt and other debris from entering the channel 360. Alternatively, the channel 360 may be disposed at regular or irregular intervals along the length of the wiping element 122. As an example, in one embodiment, the channel 360 may be discontinuously disposed along the length of the wiping element 122 such that multiple channel sections are separated by solid regions of the wiping head 334.

In the embodiment illustrated in FIG. 3, the upper legs 342 and the lower legs 346 are each substantially planar in an uncompressed, or relaxed state. Alternatively, the legs may be curved, such as for example having a convex or concave shape relative to channel 360.

In one particular example of the embodiment illustrated in FIG. 3, an angle A between each upper leg 342 and the lower flange 326 is approximately 40 degrees. Within the channel, an upper angle B between an inner surface of the upper legs 342 is approximately 100 degrees, and a lower angle C between an inner surface of the lower legs 346 is approximately 80 degrees.

In the embodiment described in the preceding paragraph, a wall thickness T of each upper leg 342 and lower leg 346 may be approximately 0.03 inches. The thickness T is measured in the cross-sectional plane illustrated in FIG. 3, which is substantially perpendicular at any location along the wiping element 122 to a longitudinal axis 372 (see FIG. 1) of the wiping element 122. In one embodiment, the thickness T and the size of the channel 360 is determined such that a total area of the upper legs 342 and the lower legs 346 in the cross-sectional plane illustrated in FIG. 3 is no greater than an area of the channel 360 at the cross-sectional plane. In another embodiment, the thickness T and the size of the channel 360 is determined such that a total area of the upper legs 342 and the lower legs 346 in the cross-sectional plane is no greater than 45% of the area of the channel 360 at the cross-sectional plane. While the angular relationship and the sizing of the components of the wiping head 334 may vary from the values provided herein, it has been found through empirical testing that the shape of the wiping head described with reference to FIGS. 1-5 and the angular and sizing relationships provided herein are particularly advantageous in improving the force distribution characteristics of the windscreen wiper.

The wiping tip 338 extends from the lower legs 346 of the wiping head 334. The wiping tip 338 is generally oriented along the axis of symmetry 356 of the wiping element 120. The wiping tip 338 includes a lower surface 376 that may be substantially planar when the windscreen wiper 110 is in an uncompressed position. When the windscreen wiper 110 is compressed against and moved across a surface of the windscreen, one of two wiping edges 380 bordering the lower surface 376 contacts the windscreen to remove rain, ice, snow, dirt, or other debris. The direction of travel of the windscreen wiper 110 determines which of the two wiping edges 380 contacts the windscreen.

In one embodiment, the wiping element 122 may be made from a silicone-based polymer. While many formulations and curing mechanisms are possible, in one embodiment, the silicone-based polymer may be addition cured by a platinum-containing catalyst. Other resilient elastomers or materials may be used instead of silicone polymers. Examples include, without limitation, natural rubber formulations or ethylene propylene diene Monomer rubber (EPDM rubber). While examples of materials comprising the wiping element 122 have been provided, it should be noted that any resilient and durable material may be used. The material may also allow a low-friction engagement between the wiping element 122 and the windscreen to reduce noise and improve wipe quality.

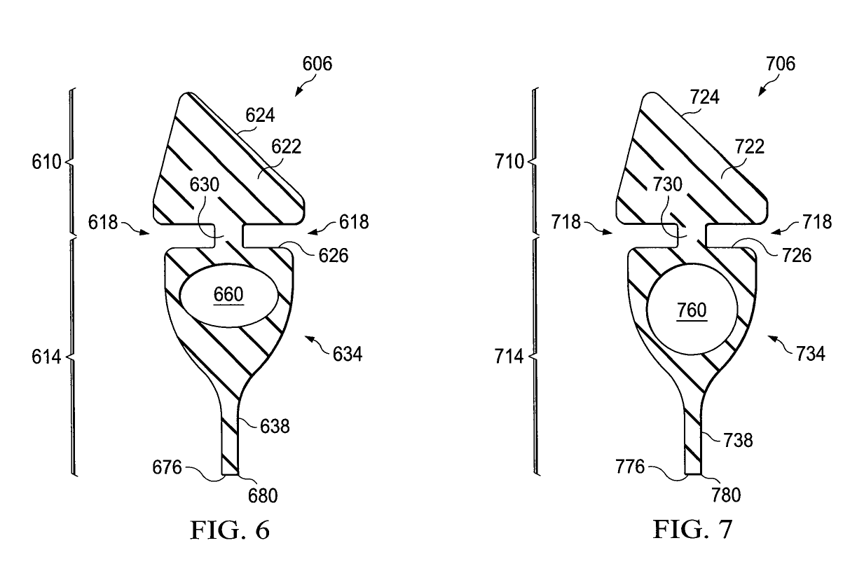

The shape of the wiping head may be varied from that shown in FIG. 3 and described above. While the wiping head 334 has been described as a kite or deltoid shape in cross-section, the wiping head 334 could be any other kind of quadrilateral or four-sided shape, including without limitation a rhombus or parallelogram. Similarly the cross-sectional shape of the channel 360 could be varied, along with the wall thickness T of the upper legs 342 and the lower legs 346 and the ratio of the wall area and the channel area. In one embodiment, the thickness of the upper legs 342 may be different than the thickness of the lower legs 346. Further, each of the upper and lower legs 342, 346 may have a different thickness than the others. As described below with reference to FIGS. 6-9, the shape of the wiping head 334 or the channel 360 may be varied.

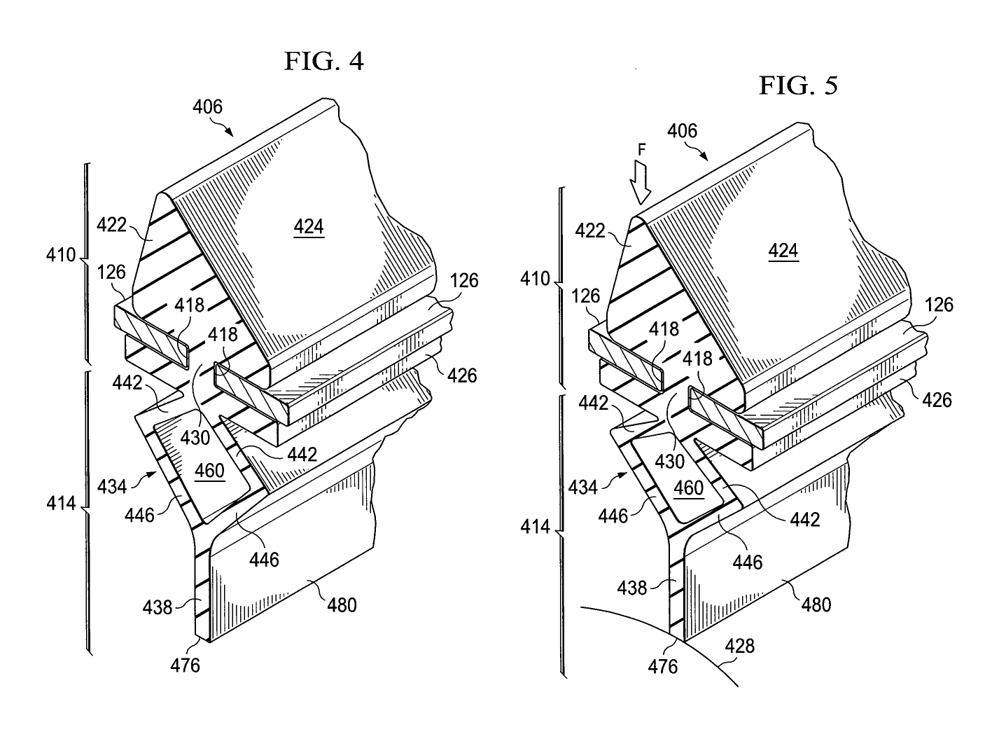

Referring to FIGS. 4 and 5, a wiping element 406 according to an illustrative embodiment is similar to the wiping element 122 shown in FIGS. 1-3. The wiping element 406 may include a head portion 410 and a wiping portion 414 connected to the head portion 410. The head portion 410 includes a channel 418 formed along each lateral side of the head portion 410. Each channel 418 is configured to receive one of the elongated splines 126 of the support element 114, and in FIGS. 4 and 5, the elongated splines 126 are shown positioned within the channels 418.

One difference between the wiping element 406 and the wiping element 122 is that the head portion 410 of wiping element 406 includes an upper flange 422 with a triangularly-shaped cross-section as opposed to the rectangular cross-section of the upper flange 322. The upper flange 422 may act as a wind deflector or spoiler that provides deflection of wind traveling over or around the wiping element 406. In one embodiment, the shape of the upper flange 422, which includes an attack surface 424, may harness wind movement or other fluid flow past the wiping element 406 to sustain an operational force on the wiping element 406 to assist in maintaining contact between the wiping element 406 and a windscreen 428 (see FIG. 5).

The head portion 410, like the head portion 210, further may include a lower flange 426 connected by an upper web 430 to the upper flange 422. Together, the upper flange 422, lower flange 426, and upper web 430 define the channels 418 positioned on each side of the web 430. The upper flange 422, the lower flange 426, the upper web 430, and the channels 418 may run an entire length of the wiping element 406.

The wiping portion 414 may be connected to the head portion 410 by a lower web similar to upper web 430, or alternatively the walls of the wiping portion may be more directly connected to the head portion 414 as illustrated in FIGS. 4 and 5. The wiping portion 414 includes a wiping head 434 and a wiping tip 438. In the embodiment illustrated in FIGS. 4 and 5, the wiping head 434 includes upper legs 442 and lower legs 446 arranged in a quadrilateral shape. More specifically, the cross-sectional shape of the wiping head 434 may be similar, or in some embodiments identical, to the shapes described previously with reference to the wiping head 334 of FIG. 3. Similar to wiping head 334, the wiping head 434 includes a channel 460 defined by the arrangement of the upper legs 442 and lower legs 446. In one embodiment, the channel 460 runs an entire length of the wiping element 406. In another embodiment, the channel 460 may be included within the wiping element 406 along the entire length except at each end of the wiping element 406. Such an arrangement may assist in preventing snow, ice, dirt and other debris from entering the channel 460. Alternatively, the channel 460 may be disposed at regular or irregular intervals along with the length of the wiping element 406.

The wiping tip 438 extends from the lower legs 446 of the wiping head 434. The wiping tip 438 includes a lower surface 476 that may be substantially planar when the windscreen wiper 110 is in an uncompressed position. When the windscreen wiper 110 is compressed against and moved across a surface of the windscreen 428, one of two wiping edges 480 bordering the lower surface 476 contacts the windscreen to remove rain, ice, snow, dirt, or other debris. The direction of travel of the wiping element 406 determines which of the two wiping edges 480 contacts the windscreen 428.

In FIG. 4, the wiping element 408 is illustrated in an uncompressed, or relaxed position. In FIG. 5, the wiping element 408 is illustrated in a compressed, or loaded position. The compressed position of the wiping element 408 is attributable to a biasing force F that is applied to the wiping element 408 and is directed toward the windscreen 428. A large component of the biasing force F may be supplied by the wiper arm (not illustrated) that is to be connected between the windscreen wiper 110 and the automobile. The wiper arm is connected to a motor on the automobile and works cooperatively with the motor to move the windscreen wiper 110 across the windscreen 428. The wiper arm is typically spring loaded to provide an arm force to the windscreen wiper 110, thereby biasing the windscreen wiper 110 toward the windscreen 428. Another component of the biasing force F may be provided by the operational force supplied by wind or other fluid flow moving over the wiping element 408.

The arm forces applied by wiper arms vary widely depending on automobile make, model, and year. Additionally, the wiper arm force may vary between vehicles that are same year, make, and model. Table 1 illustrates the Society of Automotive Engineers (SAE)—recommended arm force (in grams) for windscreen wipers based on the length of the wiper. As indicated by the table, the actual average force supplied by wiper arms for a particular wiper length typically varies from the recommended values. Additionally, the low and high force values measured for representative wiper arms illustrate the range of forces that may be encountered for a particular length of wiper blade.

TABLE 1

| Length | SAE | Actual Average | High | Low |
|---|---|---|---|---|
| 17 | 724 | 648 | 710 | 605 |
| 18 | 766 | 687 | 735 | 650 |
| 19 | 809 | 701 | 755 | 650 |
| 20 | 851 | 768 | 840 | 695 |
| 21 | 894 | 847 | 910 | 780 |
| 22 | 936 | 872 | 940 | 800 |
| 24 | 1022 | 842 | 900 | 805 |
| 26 | 1107 | 1046 | 1070 | 1000 |
| 28 | 1192 | 1072 | 1145 | 1030 |

Because the arm forces applied by wiper arms vary widely, wiping quality can be inconsistent. When the predisposed arc of the support element and the wiping element is placed against the windscreen, the support element and the wiping element should fully conform at a proper angle to the varying angles and radius aspects of the windscreen at all points during operational motion. With higher arm forces, the windscreen wiper (and thus the wiping element) experience more compression in the center of the wiping element, which is typically where the wiper arm is attached to the windscreen wiper. This increased compression in one region of the wiping element affects the angle of attack associated with the wiping element, and the friction between the wiping element and the windscreen increases in the area of increased compression, thereby resulting in chatter and noise. With lower arm forces, the wiping element may not make contact across the entire length of the wiping element as the wiping element is moved across the windscreen. This will result in missed wipe areas.

Generally considered, wipe and cleaning performance is affected by the ability of the wiping element to flex in the proper direction at the correct angle to provide a clear wipe. If the pressure distribution is not uniform or balanced, streaks, missed wipe areas, and noise will occur. For example, if a balanced pressure is not applied across the length of the wiping element, the wiping tip may reverse or straighten from its intended position. This condition may result in chatter and missed wipe areas.

The wiping elements described in FIGS. 1-5 improve the ability of the wiping elements to provide consistent wipe quality across a wide range of automobiles and varying arm forces. The improved wiping characteristics are attributed to the ability of the wiping element to deflect as shown in FIG. 5. In regions along the length of the wiping element that encounter higher forces, more deflection of the wiping element occurs, which results in a more even distribution of forces along the length of the wiping element.

Referring to FIG. 6, a wiping element 606 according to an illustrative embodiment may be used with the other components of windscreen wiper 110 described in FIG. 1. The wiping element 606 may include a head portion 610 and a wiping portion 614 connected to the head portion 610. The head portion 610 includes a channel 618 formed along each lateral side of the head portion 610. Each channel 618 is configured to receive one of the elongated splines 126 of the support element 114.

The head portion 610 of wiping element 606 may includes an upper flange 622 having a triangularly-shaped cross-section similar to the cross-section of upper flange 422 illustrated in FIGS. 4 and 5. The upper flange 622 may act as a wind deflector or spoiler that provides deflection wind traveling over or around the wiping element 606. In one embodiment, the shape of the upper flange 622, which includes an attack surface 624, may harness wind movement or other fluid flow past the wiping element 406 to sustain an operational force on the wiping element 606 to assist in maintaining contact between the wiping element 606 and a windscreen.

In the embodiment illustrated in FIG. 6, the wiping portion 614 of the wiping element 606 includes a shoulder 626 to which the upper flange 622 is connected by a web 630. Together, the upper flange 622, shoulder 626, and web 630 define the channels 618 positioned on each side of the web 630. The upper flange 622, the shoulder 626, the web 630, and the channels 618 may run an entire length of the wiping element 606.

The wiping portion 614 includes a wiping head 634 and a wiping tip 638. In the embodiment illustrated in FIG. 6, the wiping head 634 includes a channel 660 having an elliptical cross-section disposed within the wiping head 634. The elliptical channel 660 is oriented such that a major axis of the ellipse is substantially parallel to a surface of the windscreen that is intended to be wiped. In one embodiment, the channel 660 runs an entire length of the wiping element 606. In another embodiment, the channel 660 may be included within the wiping element 606 along the entire length except at each end of the wiping element 606. Such an arrangement may assist in preventing snow, ice, dirt and other debris from entering the channel 660. Alternatively, the channel 660 may be disposed at regular or irregular intervals along the length of the wiping element 606.

The wiping tip 638 extends from the wiping head 634. The wiping tip 638 includes a lower surface 676 that may be substantially planar when the windscreen wiper 110 is in an uncompressed position. When the windscreen wiper 110 is compressed against and moved across a surface of the windscreen, one of two wiping edges 680 bordering the lower surface 676 contacts the windscreen to remove rain, ice, snow, dirt, or other debris. The direction of travel of the wiping element 606 determines which of the two wiping edges 680 contacts the windscreen.

In FIG. 6, the wiping element 608 is capable of deflecting in the presence of a biasing force similar to that described above with reference to wiping element 408. The wiping head 634 and the presence of the elliptical channel 660 within the wiping head 634 may improve the ability of the wiping element 608 to provide consistent wipe quality across a wide range of automobiles and varying arm forces. In regions along the length of the wiping element 608 that encounter higher forces, more deflection of the wiping element 608 occurs, which results in a more even distribution of forces along the length of the wiping element 608.

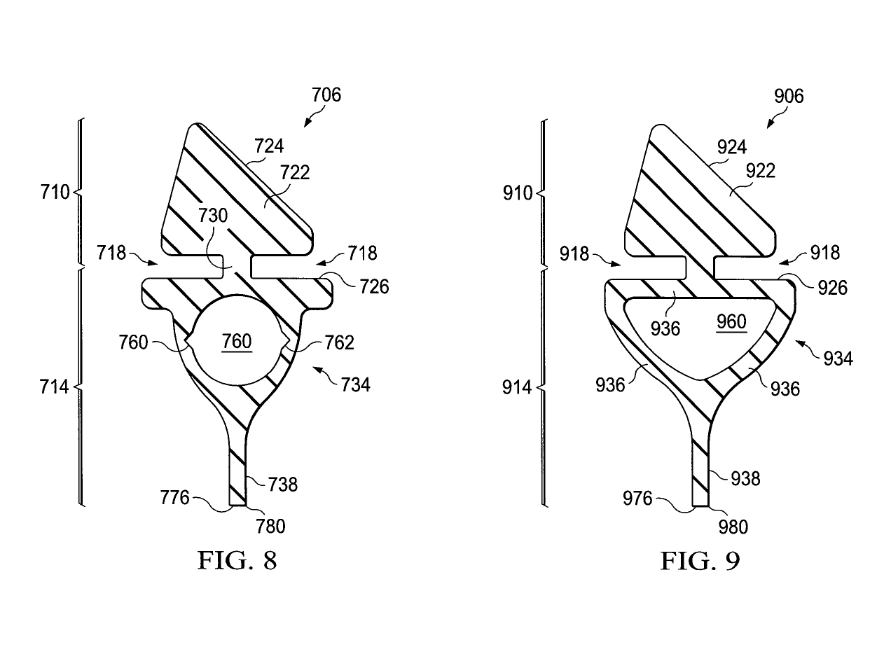

Referring to FIGS. 7 and 8, a wiping element 706 according to an illustrative embodiment may be used with the other components of windscreen wiper 110 described in FIG. 1. The wiping element 706 may include a head portion 710 and a wiping portion 714 connected to the head portion 710. The head portion 710 includes a channel 718 formed along each lateral side of the head portion 710. Each channel 718 is configured to receive one of the elongated splines 126 of the support element 114.

The head portion 710 of wiping element 706 may includes an upper flange 722 having a triangularly-shaped cross-section similar to the cross-section of upper flange 422 illustrated in FIGS. 4 and 5. The upper flange 722 may act as a wind deflector or spoiler that provides deflection wind traveling over or around the wiping element 706. In one embodiment, the shape of the upper flange 722, which includes an attack surface 724, may harness wind movement or other fluid flow past the wiping element 706 to sustain an operational force on the wiping element 706 to assist in maintaining contact between the wiping element 706 and a windscreen.

In the embodiments illustrated in FIGS. 7 and 8, the wiping portion 714 of the wiping element 706 includes a shoulder 726 to which the upper flange 722 is connected by a web 730. In the embodiment illustrated in FIG. 8, the shoulder 726 is slightly extended to form a flange similar to lower flange 426. Together, the upper flange 722, shoulder 726, and web 730 define the channels 718 positioned on each side of the web 730. The upper flange 722, the shoulder 726, the web 730, and the channels 718 may run an entire length of the wiping element 706.

The wiping portion 714 includes a wiping head 734 and a wiping tip 738. In the embodiment illustrated in FIGS. 7 and 8, the wiping head 734 includes a channel 760 having a circular cross-section disposed within the wiping head 734. In the embodiment illustrated in FIG. 8, the circular cross-sectional shape of the channel 760 further includes notches 762. In one embodiment, the channel 760 runs an entire length of the wiping element 706. In another embodiment, the channel 760 may be included within the wiping element 706 along the entire length except at each end of the wiping element 706. Such an arrangement may assist in preventing snow, ice, dirt and other debris from entering the channel 760. Alternatively, the channel 760 may be disposed at regular or irregular intervals along the length of the wiping element 706.

The wiping tip 738 extends from the wiping head 734. The wiping tip 738 includes a lower surface 776 that may be substantially planar when the windscreen wiper 110 is in an uncompressed position. When the windscreen wiper 110 is compressed against and moved across a surface of the windscreen, one of two wiping edges 780 bordering the lower surface 776 contacts the windscreen to remove rain, ice, snow, dirt, or other debris. The direction of travel of the wiping element 706 determines which of the two wiping edges 780 contacts the windscreen.

In FIGS. 7 and 8, the wiping element 708 is capable of deflecting in the presence of a biasing force similar to that described above with reference to wiping element 408. The wiping head 734 and the presence of the circular channel 760 within the wiping head 734 may improve the ability of the wiping element 708 to provide consistent wipe quality across a wide range of automobiles and varying arm forces. It is believed that the presence of the notches 762 in the circular cross-section shape of the channel 760 will improve the ability of the wiping element to deflect under the influence of the biasing force. In regions along the length of the wiping element 708 that encounter higher forces, more deflection of the wiping element 708 occurs, which results in a more even distribution of forces along the length of the wiping element 708.

Referring to FIG. 9, a wiping element 906 according to an illustrative embodiment may be used with the other components of windscreen wiper 110 described in FIG. 1. The wiping element 906 may include a head portion 910 and a wiping portion 914 connected to the head portion 910. The head portion 910 includes a channel 918 formed along each lateral side of the head portion 910. Each channel 918 is configured to receive one of the elongated splines 126 of the support element 114.

The head portion 910 of wiping element 906 may includes an upper flange 922 having a triangularly-shaped cross-section similar to the cross-section of upper flange 422 illustrated in FIGS. 4 and 5. The upper flange 922 may act as a wind deflector or spoiler that provides deflection wind traveling over or around the wiping element 906. In one embodiment, the shape of the upper flange 922, which includes an attack surface 924, may harness wind movement or other fluid flow past the wiping element 906 to sustain an operational force on the wiping element 906 to assist in maintaining contact between the wiping element 906 and a windscreen.

In the embodiments illustrated in FIG. 9, the wiping portion 914 of the wiping element 906 includes a shoulder 926 to which the upper flange 922 is connected by a web 930. Together, the upper flange 922, shoulder 926, and web 930 define the channels 918 positioned on each side of the web 930. The upper flange 922, the shoulder 926, the web 930, and the channels 918 may run an entire length of the wiping element 906.

The wiping portion 914 includes a wiping head 934 and a wiping tip 938. In the embodiment illustrated in FIG. 9, the wiping head 934 includes a channel 960 having a substantially triangular cross-section disposed within the wiping head 934. An exterior perimeter of the wiping head 934 (in cross-section) may be substantially similar in shape to the cross-sectional shape of the channel 960. This similarity in shapes permits a wall 936 of the wiping head 934 to have a relatively constant thickness. In one embodiment, the channel 960 runs an entire length of the wiping element 906. In another embodiment, the channel 960 may be included within the wiping element 906 along the entire length except at each end of the wiping element 906. Such an arrangement may assist in preventing snow, ice, dirt and other debris from entering the channel 960. Alternatively, the channel 960 may be disposed at regular or irregular intervals along the length of the wiping element 906.

The wiping tip 938 extends from the wiping head 934. The wiping tip 938 includes a lower surface 976 that may be substantially planar when the windscreen wiper 110 is in an uncompressed position. When the windscreen wiper 110 is compressed against and moved across a surface of the windscreen, one of two wiping edges 980 bordering the lower surface 976 contacts the windscreen to remove rain, ice, snow, dirt, or other debris. The direction of travel of the wiping element 906 determines which of the two wiping edges 980 contacts the windscreen.

The wiping element 908 illustrated in FIG. 9 is capable of deflecting in the presence of a biasing force similar to that described above with reference to wiping element 408. The wiping head 934 and the presence of the triangular channel 960 within the wiping head 934 may improve the ability of the wiping element 908 to provide consistent wipe quality across a wide range of automobiles and varying arm forces. It is believed that the relatively constant wall thickness of the wiping head 934 surrounding the channel 960 will improve the ability of the wiping element to deflect under the influence of the biasing force, especially when the ratio of an area of the wall in cross-section to an area of the channel in cross-section is similar to that described previously with respect to FIG. 3. In regions along the length of the wiping element 908 that encounter higher forces, more deflection of the wiping element 908 occurs, which results in a more even distribution of forces along the length of the wiping element 908.

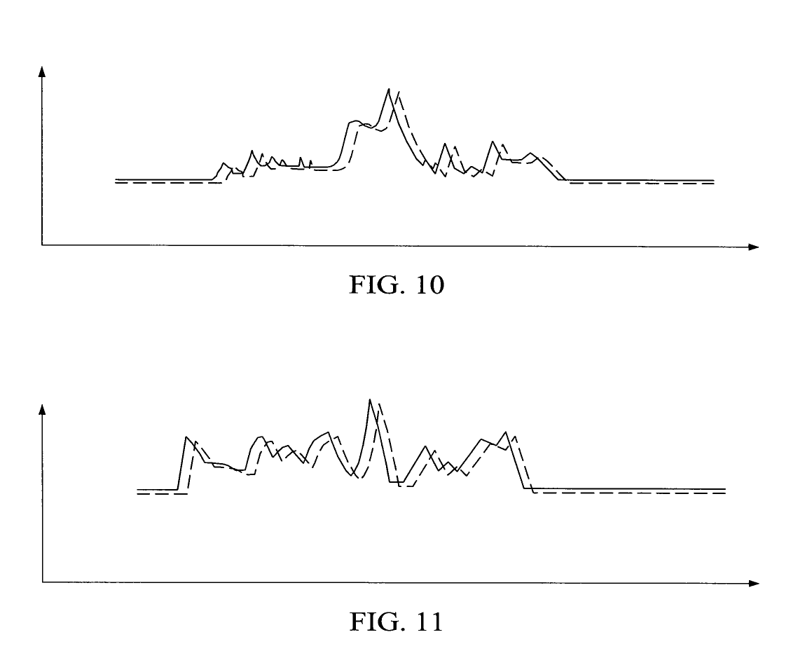

Referring to FIG. 10, a graphical illustration is provided showing the results of force testing on a typical beam-style windscreen wiper. The graph depicts force readings measured along a length of the wiping element, the length of the wiping element being represented on the horizontal axis and the force represented on the vertical axis. A biasing force was applied to the windscreen wiper in the center of the wiper, and the graph demonstrates that higher levels of force were measured on a bottom surface of the wiping element in areas nearest the applied biasing force.

Referring to FIG. 11, a graphical illustration is provided showing the results of force testing on a beam-style windscreen wiper that includes a wiping element with a wiping head similar to wiping head 334 of FIG. 3. The graph depicts force readings measured along a length of the wiping element, the length of the wiping element being represented on the horizontal axis and the force represented on the vertical axis. A biasing force was applied to the windscreen wiper in the center of the wiper. The graph indicates that a more even distribution of force was obtained using wiping head 334 as compared to the force distribution associated with the graph in FIG. 10.

The wiping elements described herein may be used with any type of windscreen wiper. Wiping elements such as those illustrated in FIGS. 1-9 have been determined to be particularly suited for use with beam-style windscreen wipers such as that illustrated in FIGS. 1 and 2. While the individual components and arrangement of those components may vary among beam-style windscreen wipers, this type of wiper commonly includes a support element or other component that is capable of biasing the wiping element into a curved or arcuate position. The deflection characteristics of the wiping elements described herein improve the distribution of force across the wiping element which results in better wiper quality.

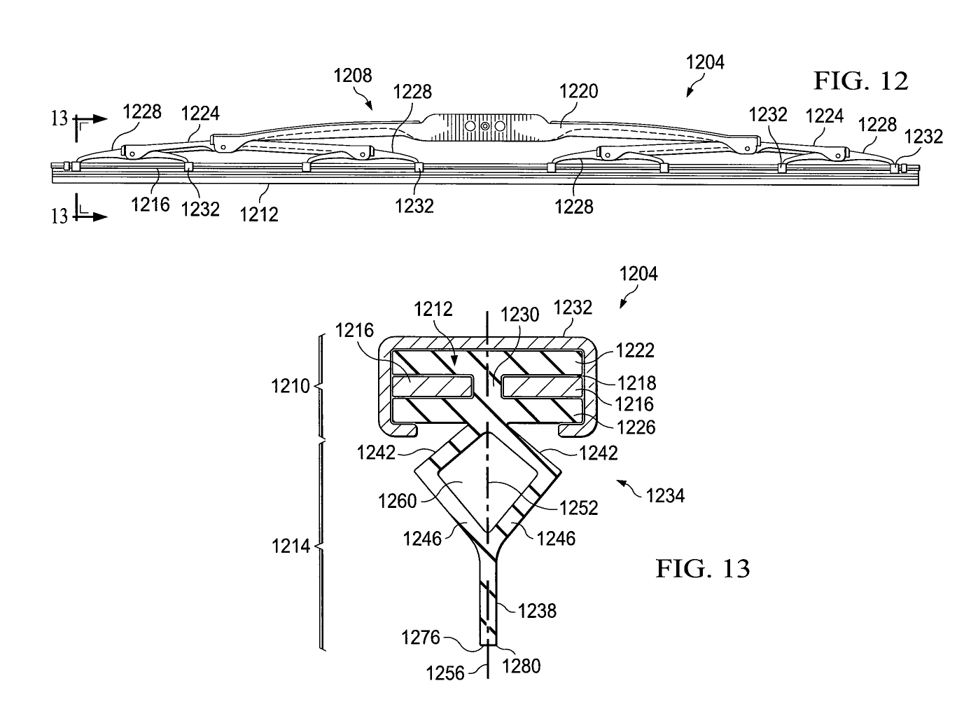

Referring to FIGS. 12 and 13, a wiper assembly 1204 having a wiper frame 1208, a wiping element 1212, and a support element, or spline, 1216 is illustrated. Wiper frame 1208 includes a primary frame portion 1220, two secondary frame portions 1224, and a plurality of tertiary frame portions 1228. Secondary and tertiary frame portions 1224, 1228, also referred to as “bridges,” are flexural members that assist in distributing force to the wiping element 1212. Secondary frame portions 1224 are pivotally connected to both ends of primary frame portion 1220. Tertiary frame portions 1228 are pivotally connected to each end of the secondary frame portions 1224. Claws 1232 are provided to attach the tertiary frame portions 1228 to the wiping element 1212. Together, the primary, secondary, and tertiary frame portions exert forces on multiple portions of wiping element 1212 to improve contact between the wiping element 1212 and the windscreen.

While the force exerted at the end of each frame portion (i.e. primary 1220, secondary 1224, or tertiary 1228), coupled with the ability of each frame portion to pivot relative to the wiper arm and the other frame portions, allows the wiping element 1212 to bend and conform to the shape of the windshield, the distribution of force along the wiping element 1212 may be improved by incorporating a wiping element with the same or similar structural characteristics to those of the wiping element 122 of FIG. 3.

The wiping element 1212 may include a head portion 1210 and a wiping portion 1214 connected to the head portion 1210. The head portion 1210 includes a channel 1218 formed along each lateral side of the head portion 1210, and each channel 1218 is configured to receive one of the support elements 1216.

Referring more specifically to FIG. 13, the head portion 1210 includes an upper flange 1222 and a lower flange 1226 connected by an upper web 1230. Together, the upper flange 1222, lower flange 1226, and upper web 1230 define the channels 1218 positioned on each side of the web 1230. The upper flange 1222, the lower flange 1226, the upper web 1230, and the channels 1218 may run an entire length of the wiping element 1212.

The wiping portion 1214 may be connected to the head portion 1210 by a lower web similar to upper web 1230, or alternatively the walls of the wiping portion may be more directly connected to the head portion 1214 as illustrated in FIG. 13. The wiping portion 1214 includes a wiping head 1234 and a wiping tip 1238. In the embodiment illustrated in FIG. 13, the wiping head 1234 includes upper legs 1242 and lower legs 1246 arranged in a quadrilateral shape. More specifically, in the embodiment illustrated in FIG. 13, the cross-sectional shape of the wiping head 1234 is a kite or deltoid shape, which includes two pairs of congruent adjacent sides. In other words, a length of each upper leg 1242 is the same as a length of the other upper leg 1242. Similarly, a length of each lower leg 1246 is equal to a length of the other lower leg 1246. Additionally, the kite or deltoid shape of the wiping head 1234 is one in which an axis of symmetry 1252 exists along a diagonal of the shape. With respect to the wiping element 1212, the axis of symmetry 1252 is coaxial with an axis of symmetry 1256 of the wiping element 1212.

The arrangement of the upper legs 1242 and lower legs 1246 defines a channel 1260 within the wiping head 1234. In one embodiment, the channel 1260 runs an entire length of the wiping element 1212. In another embodiment, the channel 1260 may be included within the wiping element 1212 along the entire length except at each end of the wiping element 1212. Such an arrangement may assist in preventing snow, ice, dirt and other debris from entering the channel 1260. Alternatively, the channel 1260 may be disposed at regular or irregular intervals along the length of the wiping element 1212.

The angular relationship of the legs 1242, 1246 to one another and other components of the wiping element 1212 may be the same as or similar to those previously described with reference to wiping element 122 of FIG. 3. Similarly, the thickness and other dimensional characteristics of the legs 1242, 1246 and channel 1260 may be the same as or similar to those previously described with reference to wiping element 122 of FIG. 3.

The wiping tip 1238 extends from the lower legs 1246 of the wiping head 1234. The wiping tip 1238 is generally oriented along the axis of symmetry 1256 of the wiping element 1212. The wiping tip 1238 includes a lower surface 1276 that may be substantially planar when the wiping element 1212 is in an uncompressed position. When the wiping element 1212 is compressed against and moved across a surface of the windscreen, one of two wiping edges 1280 bordering the lower surface 1276 contacts the windscreen to remove rain, ice, snow, dirt, or other debris. The direction of travel of the wiping element 1212 determines which of the two wiping edges 1280 contacts the windscreen.

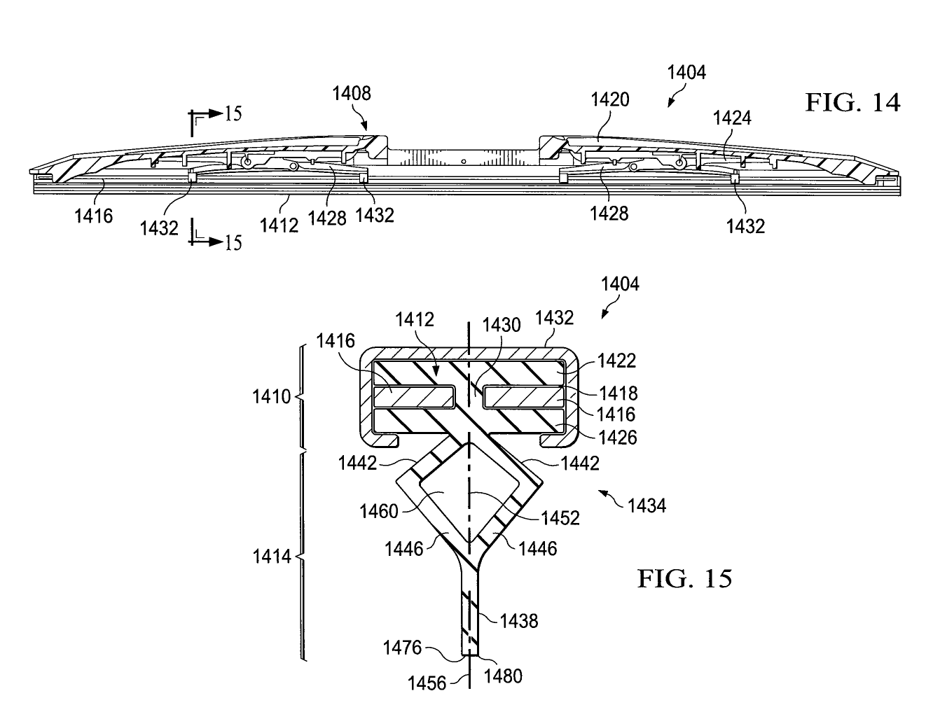

Referring to FIGS. 14 and 15, a wiper assembly 1404 having a wiper frame 1408, a wiping element 1412, and a support element, or spline, 1416 is illustrated. Wiper frame 1408 is a “hybrid” design that incorporates bridge-type frame components with a pre-curved support element similar to support element 114 of the beam-style design of FIG. 1. Wiper frame 1408 includes a primary frame portion 1420, at least one secondary frame portion 1424, and at least one tertiary frame portion 1428. Secondary and tertiary frame portions 1424, 1428, also referred to as “bridges,” are flexural members that assist in distributing force to the wiping element 1412. Secondary frame portions 1424 are connected to both ends of primary frame portion 1420. Tertiary frame portions 1428 are pivotally connected to at least one end of each secondary frame portion 1424. Claws 1432 are provided to attach the second and tertiary frame portions 1424, 1428 to the wiping element 1412. Together, the primary, secondary, and tertiary frame portions, along with the pre-curved, arcuate support element 1416, exert forces on multiple portions of wiping element 1412 to improve contact between the wiping element 1412 and the windscreen.

While the force exerted on the wiping element 1412 assists in conforming the wiping element 1412 to the windscreen, the distribution of force along the wiping element 1412 may be improved by incorporating a wiping element with the same or similar structural characteristics to those of the wiping element 122 of FIG. 3.

The wiping element 1412 may include a head portion 1410 and a wiping portion 1414 connected to the head portion 1410. The head portion 1410 includes a channel 1418 formed along each lateral side of the head portion 1410, and each channel 1418 is configured to receive one of the support elements 1416.

Referring more specifically to FIG. 15, the head portion 1410 includes an upper flange 1422 and a lower flange 1426 connected by an upper web 1430. Together, the upper flange 1422, lower flange 1426, and upper web 1430 define the channels 1418 positioned on each side of the web 1430. The upper flange 1422, the lower flange 1426, the upper web 1430, and the channels 1418 may run an entire length of the wiping element 1412.

The wiping portion 1414 may be connected to the head portion 1410 by a lower web similar to upper web 1430, or alternatively the walls of the wiping portion may be more directly connected to the head portion 1414 as illustrated in FIG. 15. The wiping portion 1414 includes a wiping head 1434 and a wiping tip 1438. In the embodiment illustrated in FIG. 15, the wiping head 1434 includes upper legs 1442 and lower legs 1446 arranged in a quadrilateral shape. More specifically, in the embodiment illustrated in FIG. 15, the cross-sectional shape of the wiping head 1434 is a kite or deltoid shape, which includes two pairs of congruent adjacent sides. In other words, a length of each upper leg 1442 is the same as a length of the other upper leg 1442. Similarly, a length of each lower leg 1446 is equal to a length of the other lower leg 1446. Additionally, the kite or deltoid shape of the wiping head 1434 is one in which an axis of symmetry 1452 exists along a diagonal of the shape. With respect to the wiping element 1412, the axis of symmetry 1452 is coaxial with an axis of symmetry 1456 of the wiping element 1412.

The arrangement of the upper legs 1442 and lower legs 1446 defines a channel 1460 within the wiping head 1434. In one embodiment, the channel 1460 runs an entire length of the wiping element 1412. In another embodiment, the channel 1460 may be included within the wiping element 1412 along the entire length except at each end of the wiping element 1412. Such an arrangement may assist in preventing snow, ice, dirt and other debris from entering the channel 1460. Alternatively, the channel 1460 may be disposed at regular or irregular intervals along the length of the wiping element 1412.

The angular relationship of the legs 1442, 1446 to one another and other components of the wiping element 1412 may be the same as or similar to those previously described with reference to wiping element 122 of FIG. 3. Similarly, the thickness and other dimensional characteristics of the legs 1442, 1446 and channel 1460 may be the same as or similar to those previously described with reference to wiping element 122 of FIG. 3.

The wiping tip 1438 extends from the lower legs 1446 of the wiping head 1434. The wiping tip 1438 is generally oriented along the axis of symmetry 1456 of the wiping element 1412. The wiping tip 1438 includes a lower surface 1476 that may be substantially planar when the wiping element 1412 is in an uncompressed position. When the wiping element 1412 is compressed against and moved across a surface of the windscreen, one of two wiping edges 1480 bordering the lower surface 1476 contacts the windscreen to remove rain, ice, snow, dirt, or other debris. The direction of travel of the wiping element 1412 determines which of the two wiping edges 1480 contacts the windscreen.

It should be recognized that while the wiping elements are described herein as being a component of a windscreen wiper on an automobile, similar embodiments may be used on other vehicles, including without limitation heavy equipment vehicles, boats, and aircraft. Additionally, the wiping elements may be used as a squeegee or other device for cleaning or clearing surfaces other than windscreens.

It should be apparent from the foregoing that an invention having significant advantages has been provided. While the invention is shown in only a few of its forms, it is not just limited but is susceptible to various changes and modifications without departing from the spirit thereof.

I claim:

1. A windscreen wiper comprising:
a wiping element having a head portion and a wiping portion, the head portion having a pair of channels, each channel disposed along a lateral side of the head portion;
a spring-like support element having a pair of elongated splines, each elongated spline received by one of the channels of the head portion; and
wherein the wiping portion of the wiping element includes a wiping head and a wiping tip extending from the wiping head, the wiping head having in cross-section a pair of upper legs and a pair of lower legs, the upper legs and the lower legs sized and arranged such that the upper legs and the lower legs form a deltoid shape, the upper legs and the lower legs further defining a deltoid-shaped channel disposed within the wiping head.

2. The windscreen wiper of claim 1, wherein each elongated spline of the support element includes a predisposed arcuate shape to bias the wiping element into a similar arcuate shape.

3. The windscreen wiper of claim 1 further comprising:
a connection bracket coupled to at least one of the wiping element and the support element to facilitate connection of the windscreen wiper to a wiper arm.

4. The windscreen wiper of claim 1 further comprising:
a wiper frame having primary, secondary, and tertiary frame portions;
wherein at least one secondary frame portion is pivotally connected to an end of the primary frame portion;
wherein at least one of the tertiary frame portions is pivotally connected to an end of the at least one secondary frame portion; and
wherein the primary, second, and tertiary frame portions assist in distributing force applied to the wiping element.

5. The windscreen wiper of claim 4, wherein:
each elongated spline of the support element includes a predisposed arcuate shape to bias the wiping element into a similar arcuate shape; and
the arcuately-shaped splines assist in distributing force applied to the wiping element.

6. The windscreen wiper of claim 1, wherein a thickness of each of the upper legs and the lower legs is approximately equal.

7. The windscreen wiper of claim 1, wherein in a cross-sectional plane substantially perpendicular to a longitudinal axis of the wiping element, a total area of the upper legs and the lower legs is not greater than an area of the deltoid-shaped channel.

8. The windscreen wiper of claim 1, wherein in a cross-sectional plane substantially perpendicular to a longitudinal axis of the wiping element, a total area of the upper legs and the lower legs is not greater than 45% of an area of the deltoid-shaped channel.

9. A windscreen wiper comprising:
a wiping element having a head portion and a wiping portion, the head portion adapted to be coupled to a wiper frame, the wiping portion having in cross-section a pair of upper legs and a pair of lower legs, the upper legs and the lower legs sized and arranged such that the upper legs and the lower legs form a deltoid shape, the upper legs and the lower legs further defining a channel disposed within the wiping head.

10. The windscreen wiper of claim 9, wherein a thickness of each of the upper legs and the lower legs is approximately equal.

11. The windscreen wiper of claim 9, wherein in a cross-sectional plane substantially perpendicular to a longitudinal axis of the wiping element, a total area of the upper legs and the lower legs is not greater than an area of the channel.

12. The windscreen wiper of claim 9, wherein in a cross-sectional plane substantially perpendicular to a longitudinal axis of the wiping element, a total area of the upper legs and the lower legs is not greater than 45% of an area of the channel.

13. A windscreen wiper comprising:
a wiping element having a head portion and a wiping portion, the head portion having a pair of channels, each channel disposed along a lateral side of the head portion;
a spring-like support element having a pair of elongated splines, each elongated spline received by one of the channels of the head portion; and
wherein the wiping portion of the wiping element includes a wiping head and a wiping tip extending from the wiping head, the wiping head having in cross-section upper and lower legs, the upper legs and the lower legs defining and surrounding a channel disposed within the wiping head, the upper and lower legs each having a substantially uniform thickness.

14. The windscreen wiper of claim 13, wherein each elongated spline of the support element includes a predisposed arcuate shape to bias the wiping element into a similar arcuate shape.

15. The windscreen wiper of claim 13 further comprising:
a connection bracket coupled to at least one of the wiping element and the support element to facilitate connection of the windscreen wiper to a wiper arm.

16. The windscreen wiper of claim 13 further comprising:
a wiper frame having primary, secondary, and tertiary frame portions;
wherein at least one secondary frame portion is pivotally connected to an end of the primary frame portion;
wherein at least one of the tertiary frame portions is pivotally connected to an end of the at least one secondary frame portion; and
wherein the primary, second, and tertiary frame portions assist in distributing force applied to the wiping element.

17. The windscreen wiper of claim 16, wherein:
each elongated spline of the support element includes a predisposed arcuate shape to bias the wiping element into a similar arcuate shape; and
the arcuately-shaped splines assist in distributing force applied to the wiping element.

18. The windscreen wiper of claim 13, wherein in a cross-sectional plane substantially perpendicular to a longitudinal axis of the wiping element, a total area of the upper and lower legs is not greater than an area of the channel disposed within the wiping head.

19. The windscreen wiper of claim 1, wherein in a cross-sectional plane substantially perpendicular to a longitudinal axis of the wiping element, a total area of the upper and lower legs is not greater than 45% of an area of the channel disposed within the wiping head.
